(19) United States
(12) Patent Application Publication
(10) Pub. No.: US 2015/0122107 A1
(43) Pub. Date: May 7, 2015

(54) INTERCHANGEABLE DRUM HEAD COVER

(71) Applicants: David C. deLoache, Watkinsville, GA (US); Charles S. Garland, Athens, GA (US)

(72) Inventors: David C. deLoache, Watkinsville, GA (US); Charles S. Garland, Athens, GA (US)

(21) Appl. No.: 14/528,561

(22) Filed: Oct. 30, 2014

Related U.S. Application Data
(60) Provisional application No. 61/898,905, filed on Nov. 1, 2013.

(51) Int. Cl. G10D 13/02

(52) U.S. Cl. CPC G10D 13/027
USPC 84/414

(57) ABSTRACT

An interchangeable drum head cover is disclosed which enables use of multiple advertisements, band identifiers or other visual indicia on a drum or like instrument. A drum head cover with a specific identifier, advertisement or other indicia printed thereon includes a flexible attachment means on its periphery that facilitates quick exchange of covers as needed. A pouch for storage of the cover can be formed as an attachment to the cover.

### CLAIM FOR PRIORITY

Applicants claim priority under 35 USC §119(e) to the benefit of U.S. Provisional Application Ser. No. 61/895,905 filed Nov. 1, 2013, which is incorporated herein by reference.

### BACKGROUND OF THE INVENTION

The basic source of providing deep bass in any music ensemble is a large bass drum. In small ensembles, such as at a nightclub venue, the drum of choice is a so-called “kick drum.” This drum is usually displayed at the front of the music ensemble and the bass sound is typically obtained by an articulated, foot-operated drum mallet striking the strike head at the rear of the drum (as viewed by the audience watching the band).

A bass drum is typically about 18-26 inches in diameter and has two heads or faces. The strike head or inboard face (directed toward drummer) when used in an ensemble setting, for example, at a club or party, is usually covered with a stretched membrane that resonates when impacted by a foot-operated drum stick. In a marching band both faces of the bass drum will be covered and resonate when impacted with hand-held drum sticks (also called batters or mallets).

The outboard face of a kick drum (directed toward the audience) used in an ensemble setting is typically open or has a decorative cover. The outboard face of the drum is readily observed by the audience and thus is a focal point of the band while performing.

### SUMMARY OF THE INVENTION

Because a bass drum is a prominent feature of any music ensemble, the outboard face of the drum is an ideal place to display the ensemble's identity or other graphics to those listening to the music. That identity may be incorporated into the outboard face of the drum that can be seen by those listening to the music. Display of the group's identity is especially important at large events like Bonnaroo, Lollapalooza and the like where large numbers of groups play. In most bands whose composition is relatively stable and uniform, the name of the music group is permanently etched or added to an outboard face of the drum seen by those listening to the music.

However, with many smaller groups of musicians a drummer might play multiple sessions with different musical groups using the same drum. However, it's not practical to have multiple drums with different names of musical groups on separate drum faces that would have to get switched out with each new performance.

Thus, there is a practical need for a means to quickly change the identity of a musical group on a frequent basis. The current invention provides the means to do so. The easy interchangeability also facilitates use of varying advertisements or other visual indicia on the drum face.

### DESCRIPTION OF THE FIGURES

FIG. 1 is a front elevational view of a typical ensemble drum assembly illustrating the placement of a kick drum with the outboard face prominently directed toward an audience

FIG. 2 is a side elevational view of the drum head cover of this invention covering the outboard face of a kick drum with a prototypical logo identifying a band.

FIG. 3 is a side elevational view of the drum head cover of this invention showing the cover held in place over the outboard face of the drum with loops.

FIG. 4 is a plan view of one embodiment of the drum head cover of this invention with attached carrying case for the cover.

### DETAILED DESCRIPTION OF THE INVENTION

The subject invention provides the naming flexibility desired by certain groups who play under different names, for different sponsors or in different venues. With many musical groups a drummer will play with up to five different bands in any given week. To facilitate the change in identification from group to group, this invention provides a means to quickly change identification as the band or group changes. The invention also provides a simple means to advertise or display other visual indicia at a band's performance venues.

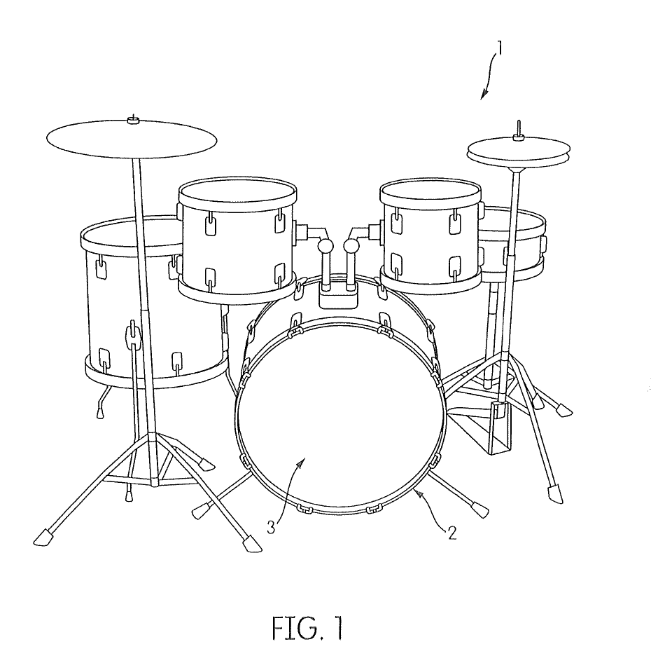

A typical arrangement of drums and associated instruments used by such bands is referred to as a drum set 1 (cymbals, bells, etc.) and is shown in FIG. 1. The centerpiece of the drum set is the kick drum, also known as a bass drum 2. As the latter name implies, this drum heavily contributes to the bass range of notes in a typical song. The bass notes are produced by an articulated pedal (not shown) on the side of the kick drum (facing away from the audience) that is foot activated by a drummer.

The front 3 of the bass drum 2 typically faces the audience and is usually the focal point of the band. It thus garners attention from the audience. It is therefore an ideal place to display the musical group's name, logo, or other visual indicia. The prominence of the front face 3 of the bass drum 2 also makes it an ideal location for advertisement of product, services, other musical or social events, as well as promotion of the musical group. It also provides a vehicle for promotion of a drum in a store where the cover could be emblazoned with the store or manufacturer's promotional material.

The front face 3 of bass drums are typically open or lightly covered with a thin membrane that readily transmits the bass sound. Since the front face has no role in producing sound it can be lightly covered without adverse effect on the band's performance. Thus, the interchangeable drum cover 4 of this invention can be placed over the front face 3 of the bass drum without impeding the band's musical performance. Or it can be placed over both faces of a bass drum to be used in a marching band to promote an academic institution or a sponsor of the band.

The drum cover 4 preferably comprises a wrinkle-free material such as polyester, lycra or spandex. Any suitable band identifier, advertisement or other visual indicia 5 can be silk screened, printed or embroidered on the cover 4.

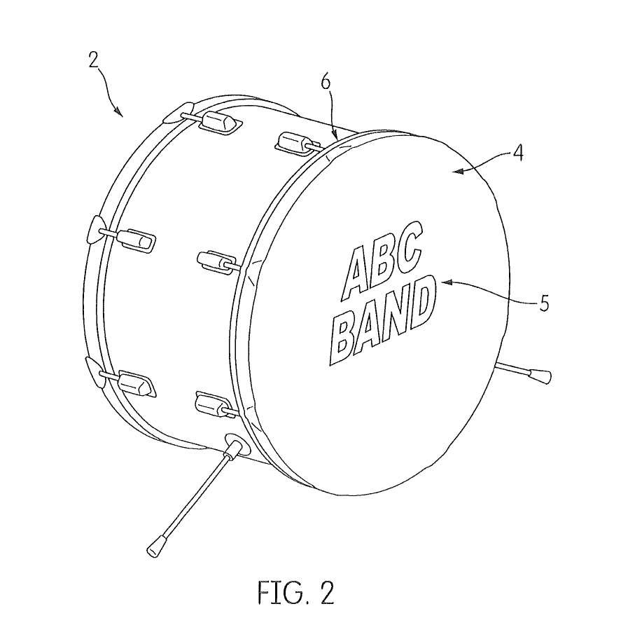

There are multiple means of retaining the cover 4 on the front face 3 of drum 2. A preferred means is an elastic cord 6 sown into outer edge of cover 4 (See FIG. 2). A cover 4 with this elastic cord sown into the edge has been found to keep the cover sufficiently taut to provide a flat surface on the front face 5 of the cover 4 where the band identifier, advertisement or other printing is located. Alternatively, a shock cord or other tensioning means which keeps the cover 4 taut can be used.

To facilitate the use of the elastic cord 6 or other cover retaining means the cover 4 is preferably dimensioned about 2 inches in diameter greater than the typical face 3 of the drum. The elastic cord is sewn into a hem about the periphery of the cover 4 to facilitate attachment and to avoid dealing with the cord as a separate item to keep track of.

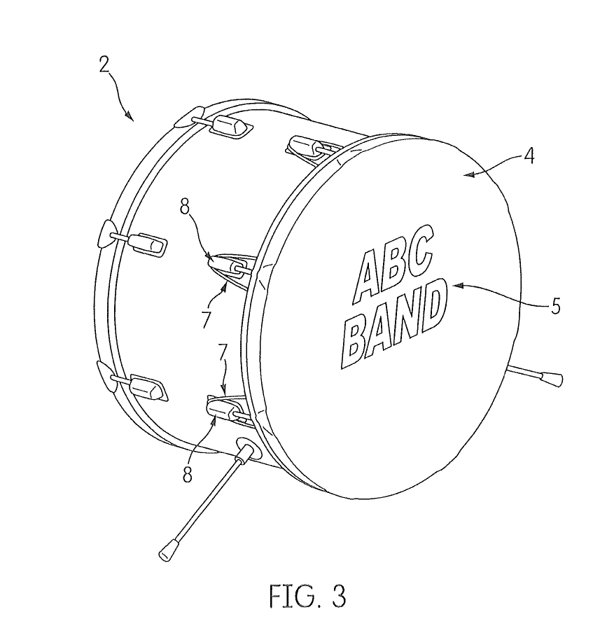

Other means of keeping the cover 4 taut over the front face 3 of the drum 2 include addition of elastic loops 7 attached to the periphery of the cover 4 that can be looped over lugs or other hardware 8 on the side of the drum as shown in FIG. 3.

With these means for quick attachment and removal of cover 4, a drummer can carry with him/her multiple covers with different band identities and/or advertisements and quickly switch covers with various identities using the features of this invention. As the drummer moves from one performance to the next performance with a different musical group, he need only break out the drum cover for that group, stretch the cover across the face of the kick drum and attach the elastic cord around the front face of the drum and the new identity is immediately apparent to the audience.

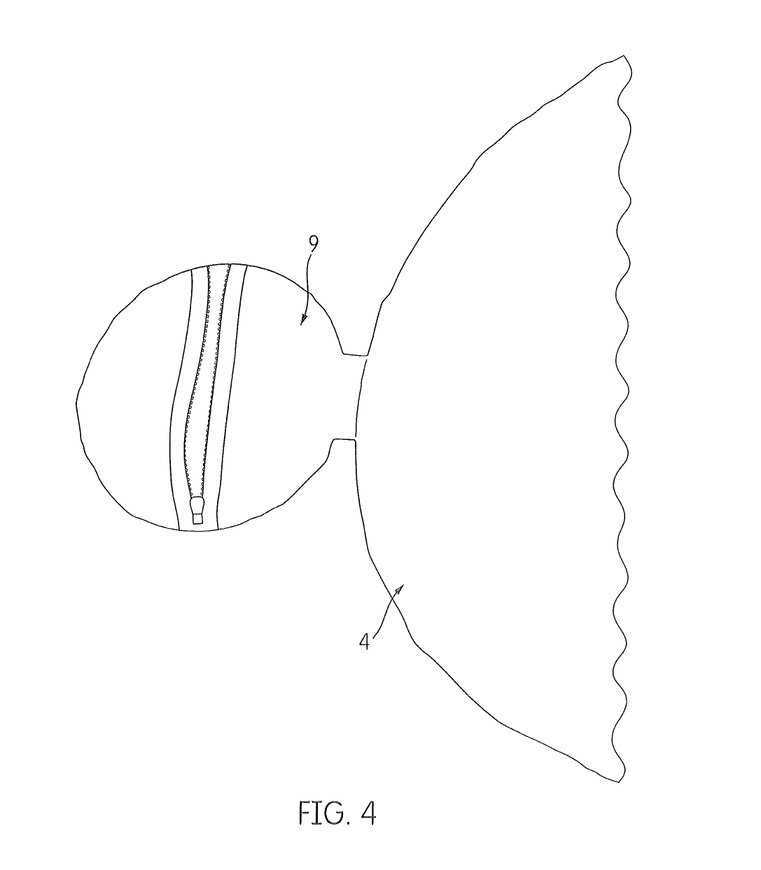

To further facilitate the portability and multiplicity of kick drum covers envisioned by this invention, the kick drum cover 4 preferably has a small pocket/pouch 9 sewn onto one portion of the cover 4 in which can be stored the entire cover that is used to cover the front face 3 of the drum 2. See FIG. 4. Thus, once a drum cover 4 is used, it can be quickly released from its attachment to the drum head and stuffed into the pouch 9 integrated into the cover 4 so that it will not be lost, thereby insuring its availability at the next venue. When the cover 4 is attached to a drum, the pouch 9 is just tucked into the inside recesses of the drum.

In a further embodiment of the invention, a small opening, for example, a 4-6″ circular aperture (not shown) can be formed in the cover 4 to allow placement of audio equipment, for example, a microphone, often used to better pick up the bass notes emitted by the drum 2.

The invention also has applicability to other forms of drums, including those used in marching bands, orchestras (timpani) and other musical settings.

We claim:

1. A drum cover comprising
a) a flat surface with visual indicia thereon; sized to cover at least one face of a drum head; and
b) flexible attachment means about the periphery of the cover for pulling the cover tightly over the head of the drum thereby creating a flat surface for the visual indicia on the cover.

2. The drum cover of claim 1, wherein the cover includes a closable pouch extending from its periphery wherein the pouch is of sufficient size to store the cover once removed from the drum head.

3. The drum cover of claim 1 wherein the flat surface thereof contains visual indicia identifying a particular musical group.

4. The drum cover of claim 1 wherein the flat surface thereof contains visual indicia comprising an advertisement.

5. The drum cover of claim 1 wherein the flexible attachment is an elastic cord.

6. The drum cover of claim 1 wherein the flexible attachment includes loops attached to the drum.

7. The drum cover of claim 1, wherein an opening is located therein to facilitate placement of audio equipment within the drum.
